(19) United States
(12) Patent Application Publication
(10) Pub. No.: US 2014/0352209 A1
(43) Pub. Date: Dec. 4, 2014

(54) PLANT SUPPORT FRAME, PLANT SUPPORT FRAME SYSTEM, AND USE OF A PLANT SUPPORT FRAME AND PLANT SUPPORT FRAME SYSTEM

(71) Applicant: Jörg Huemer, Roitham (AT)

(72) Inventor: Jörg Huemer, Roitham (AT)

(21) Appl. No.: 14/273,334

(22) Filed: May 8, 2014

(30) Foreign Application Priority Data
May 8, 2013 (DE) 10 2013 008 000.2

(51) Int. Cl. A01G 9/12

(52) U.S. Cl. CPC A01G 9/12
USPC 47/44

(57) ABSTRACT

A plant support frame for supporting plants, comprising a rod attachment for supporting flat holding elements adapted for receiving a vertically adjustable rod, said rod attachment comprising a substantially H-shaped attachment member having a first slot, a first recess and a first connecting web formed between the first slot and the first recess, wherein the first recess is laterally defined by two first substantially parallel limbs, wherein the first limbs are connected to each other by means of the first connecting web, and wherein the first slot and the first recess extend from the first connecting web in opposite directions; and a substantially U-shaped attachment member having a second recess and a second slot extending therefrom, wherein the second recess is laterally defined by two second substantially parallel limbs; wherein the H-shaped attachment member and the U-shaped attachment member are flat in shape; and wherein the H-shaped attachment member is adapted for attachment to a first end of the rod, and wherein the U-shaped attachment member is attached to the H-shaped attachment member in a crosswise manner relative to the H-shaped attachment member so that the first slot engages the second slot, wherein the two first limbs and the two second limbs form a first enclosure so that the rod can be firmly locked at its periphery in this first enclosure by the first and second limbs.

The present invention relates to a plant support frame, a plant support frame system, and a use of such a plant support frame or such a plant support frame system.

For stabilizing plant shoots, for example for preventing progress of wind or weather-related damage to outdoor plants, usually plant support frames are used, at which plant shoots are re-erected by tying. Classic representatives of such plant support frames are rods, e.g. of bamboo. Such rods are usually inserted in sections, by hand or with the aid of tools, into the soil in the vicinity of the plant shoot to be supported and are thus fixed. The plant shoot can be attached to a single rod or a plurality of rods by means of binding materials or clips, thereby stabilizing it.

Plant support frames are also used with indoor or potted plants protected from wind and weather. In this case, stabilization of the plant shoot usually serves the purpose of avoiding damage to the plant shoot by its own weight or preventing the progress of a damage extrinsically inflicted on the plant. Plant support frames are further used for aesthetic purposes, for example, when the direction of growth of plant shoots is to be predetermined.

In accordance with the variety of plant genera, various genus-specifically shaped plant support frames exist. For roses and other climbing or creeping plants, usually obelisks, round arches or wall trellises are used. A plant support for supporting orchids is described in document EP 2090155 A1. This plant support comprises a vertically positionable main carrier and a plurality of holding elements wound into a spiral arranged thereon. For example, the holding elements are arranged vertically on top of each other at various levels or are arranged relative to each other in various orientations on the main carrier and are made of wire or are injection molded parts.

A plant support frame for tying up plants is known from document DE 8107765 U1. It is comprised of a frame rod having laterally protruding bar elements, wherein the bar elements are arranged on the frame rod on one end only and thus have a free end. A plant shoot to be tied up can thus be introduced from the side of the free ends of the bar elements into the area between two bar elements, wherein greater shoot lengths are passed through a plurality of areas between two respective adjacent bar elements in a zigzag or slalom-like manner.

It is the object of the present invention to provide a plant support frame and plant support frame system versatile in use, while simple in manufacture and transport. It is further an object of the invention to provide a use of a plant support frame and plant support frame system of this kind.

The plant support frame is provided for straightforward use outdoors as well as for tub and roof garden plants and can do without additional fasteners. It is suitable for both, prophylactically securing the natural habitus or the aesthetic optimum of the respective plant and reconstructing the same in the case of occurred damage.

This object is achieved by a plant support frame having the features of claim 1, a plant support frame having the features of claim 9, a plant support frame system having the features of claim 12, and a use of a plant support frame or plant support frame system having the features of claim 13.

A plant support frame (i.e., a plant rack) for supporting plants comprises a rod attachment (rod cap) for supporting flat holding elements adapted for receiving an elongate vertically adjustable rod. The rod attachment comprises a substantially H-shaped attachment member having a first slot, a first recess and a first connecting web formed between the first slot and the first recess. The first recess is laterally defined by two first substantially parallel limbs. The first limbs are connected to each other by means of the first connecting web. The first slot and the first recess extend from the first connecting web in opposite directions.

The rod attachment further comprises a substantially U-shaped attachment member having a second recess and a second slot extending therefrom. The second recess is laterally defined by two second substantially parallel limbs.

The H-shaped attachment member and the U-shaped attachment member are flat in shape. The H-shaped attachment member is adapted for attachment to a first end of the rod, wherein the U-shaped attachment member is attached/stuck/plugged to the H-shaped attachment member in a crosswise manner relative to the H-shaped attachment member. The first slot engages the second slot so that the two first limbs and the two second limbs form a first enclosure so that the rod can be locked at its periphery in this first enclosure by the first and second limbs. Preferably, the rod is locked in an accurately fitting manner. Optionally, the rod is firmly locked.

When the first slot engages the second slot, the base of the first slot, i.e. the innermost point of the first slot, and the base of the second slot, i.e. the innermost point of the second slot, preferably contact each other.

Since the rod attachment is adapted for attachment to a rod of arbitrary length already inserted into the soil, the plant support frame can be used substantially irrespective of the character of the ground. The plant support frame is attachable to a rod made of an arbitrary material. The rod can be made of metal, for example stainless steel, steel or aluminum, of wood or plastic material, in form of a plain cylinder or hollow cylinder in each case. For hard or stony ground outdoors, especially a rod made of an impact-resistant material, for example steel, is provided which can be driven into the ground by means of a hammer.

Spaced apart steps can be formed on the plant support frame on one of the two limbs of the U-shaped attachment member or the H-shaped attachment member. The holding elements can rest on said steps. The holding elements can each further comprise one recess adapted for receiving the rod and the first limb in a manner protruding therethrough, thereby holding the holding elements horizontally. Preferably, the holding elements comprise one or more hook-shaped portions for fixing parts of plant shoots. The holding elements thus enable stabilizing a plurality of horizontally spaced apart shoots by means of a single rode in a time and material-saving manner so that inserting a plurality of rods into the soil and thus damage in the root area associated therewith is avoided.

The specific configuration of the holding elements enables receiving plant elements in a flexible and uniformly distributed manner, thereby enabling reconstruction or prophylactic protection of the original loose habitus of the plant. The flat holding elements also serve the purpose of supporting loads above the soil. They can be suitable for supporting fruit resting thereon or vessels filled with root substrate for reproduction purposes by layers or, especially when used with indoor plants, vessels filled with water for locally increasing air moisture.

By means of the steps, a plurality of holding elements optionally of various forms can be arranged on top of each other. The steps can serve the purpose of supporting holding elements for one or two solitary plant shoots.

A closing element can rest on a holding element. This closing element can be vertically displaceable across the steps along the rod and along the limb.

Furthermore, the closing element can be held by the limb in a torque-proof manner. After introducing the plant shoot to be secured, the closing element can close off openings in the contour of the holding element.

Alternatively, the holding element may serve as a support for a label. For this purpose, it can be shaped as a plate. This plate can either be directly inscribable or act as a support for a label resting thereon. For fixing the label, a frame member can rest on the label supported by the holding element and can thus fix the peripheral area of the label in a weighting manner. The frame member can rest thereon in fixing manner. The label can be elastic and adapted for attachment to the rod.

A special form of a holding element, which has proven useful from a horticultural point of view, comprises a double gripper extending in two opposite directions, the inlets of which to two separate internal openings can be closed off by a closing element resting thereon, which permits parallel introduction of solitary shoots when in a raised position.

In a preferred embodiment of the plant support frame, the H-shaped attachment member and the U-shaped attachment member each comprise two horizontal beams defining a support plane. The two beams can cooperatively support a holding element in the support plane. The rod attachment penetrates the holding element in the area of a central cruciform recess.

In its outer contour, the holding element can comprise openings to recesses of the holding element. The recesses can, at least in sections, be shaped in form of a labyrinth. Preferably, the recesses of the entire holding element are shaped in form of a labyrinth. However, the recesses can alternatively also be integrally or sectionally shaped in form of a hook or frame. When the recesses are shaped in form of a labyrinth, even fully developed plant shoots can be captively held when introduced laterally. No further means are required for fastening the plant shoots.

Optionally, the holding element itself can be horizontally fixed by a ring having a cruciform recess, the contour of which is sufficient in size in a horizontal rotational position to be penetrated by the assembled attachment members so that the ring can be centrally applied to the holding element and its four inwardly increasingly broadening wings can be moved, by means of rotation, into accurately fitting recesses of the attachment members until it is engaged in its final position by means of slight tension.

By means of this holding element, a shoot already supported by a hook-shaped holding element in a solitary manner can be provided with an optimum support at a higher level even if it is multi-branched. This has the advantage that the entire trellis will not dominate the visual appearance at the expected final height already in early stages of development of the plant and that it can be reacted to unexpected height growth without any problems. For climbing and creeping plants, hitherto undreamed of possibilities of free-standing solitary use arise from this design when used outdoors. When used with tub plants, there is a need for stabilization analogous to clump-forming outdoor bushes, however, predominantly in the assortment of suitable climbing and creeping plants, in case which the trellis can grow together with the plant in a demand oriented manner.

The labyrinth-like recesses are characterized by the fact that they spontaneously change direction. This enables engaging plant shoots in various locations of this internal configuration and thus fixing each shoot, for example, of a clumping bush in an individual position. Since it is sufficient for the statics of the plant shoots to insert a holding element structured in this way below its vertical center, it is virtually invisible in practical application since it is covered by foliage and possibly small lateral shoots and blossoms. Such holding elements thus enable prophylactic protection or, after falling apart of a clump due to storm or the weight of rain, reconstruction of its aesthetically optimum, loose, natural habitus without any trouble by introducing initially the most central shoots, then the shoots further remote from the center through the inlets into the horizontal element held by the rod above the center of the clump and fixing them in the desired position.

In a preferred embodiment, the H-shaped attachment member comprises a first limb elongated in an arcuate manner and a second limb elongated in an arcuate manner being symmetrical thereto with respect to a central axis of the H-shaped attachment member, and the U-shaped attachment member includes an arcuate elongation. At its/their distal end(s), one or more elongated limbs can each comprise a fork-like gripping device with an opening facing the rod, which support a holding element. For stabilization, the holding element can further comprise a bore which can be penetrated by the rod. In this embodiment, the holding element preferably has a labyrinth-like internal structure not including any inlets for introducing plant shoots on the side facing away from the rod. Such a rod attachment especially meets the specific requirements for stabilizing shoots of clump-shaped bushes in the habitat woodland/border according to the key of Prof. Sieber, which have specific stabilization requirements due to their unilateral orientation towards the light. In particular in outdoor use, hanging basket plants can alternatively be supported at a predetermined height above the ground by this trellis form and the drooping shoots can be fixed in a vertical and radial arrangement around the plant.

In a preferred embodiment, the plant support frame further comprises a foot for supporting the rod in a vertical orientation. The foot comprises a substantially H-shaped foot member having a third slot, a third recess and a second connecting web formed between the third slot and the third recess. The third recess is laterally defined by two third substantially parallel limbs. The third limbs are connected to each other by means of the second connecting web, wherein the third slot and the third recess extend from the second connecting web in opposite directions. The foot further comprises a substantially U-shaped foot member having a fourth recess and a fourth slot extending therefrom. The fourth recess is laterally defined by two fourth substantially parallel limbs. The H-shaped foot member and the U-shaped foot member are flat in shape. Furthermore, the H-shaped foot member is adapted for attachment to a second end of the rod, and the U-shaped foot member is adapted for attachment to the H-shaped foot member in a crosswise manner relative to the H-shaped foot member so that the third slot engages the fourth slot. The two third limbs and the two fourth limbs form a second enclosure so that the rod can be locked at its periphery in this second enclosure by the third and fourth limbs.

Alternatively or in addition thereto, the foot can be used as a rod attachment for supporting vessels with hanging basket plants centrally above the rod. This enables uniform fixing of drooping plant shoots below the plant in a radial arrangement.

In a preferred embodiment, the plant support frame comprises a connection adapter comprising a first and a second substantially H-shaped connecting member. The first H-shaped connecting member comprises a fifth and a sixth recess and a fifth slot, and the second H-shaped connecting member comprises a seventh and an eighth recess and a sixth slot. The fifth recess is laterally defined by two substantially parallel fifth limbs, the sixth recess is laterally defined by two substantially parallel sixth limbs, the seventh recess is laterally defined by two substantially parallel seventh limbs, and the eighth recess is laterally defined by two substantially parallel eighth limbs.

The inner contours of the first and second connecting members can be symmetrical with respect to a common central axis of symmetry and the first and second connecting member can be assembled in a crosswise manner. More specifically, the second H-shaped connecting member is attached to the first H-shaped connecting member in a crosswise manner relative to the first H-shaped connecting member so that the fifth slot engages the sixth slot.

The two sixth limbs and the two eighth limbs form a third enclosure so that the rod can be firmly locked in this third enclosure. Furthermore, the two fifth limbs and the two seventh limbs form an addition enclosure so that an additional rod can be firmly locked at its periphery by the fifth and seventh limbs.

The connection adapter can be provided for extending the plant support frame in a vertical direction. For example, instead of a long rod, a plurality of short rods can be connected by means of the connection adapter. The rods can optionally have different diameters. Furthermore, it can thus be avoided that the plant support frame exceeds the height of the plant during stages of development with the aesthetic ambition to keep its use as unobtrusive as possible.

The outer contour of this connection adapter is preferably shaped such that it includes bulges (step-like enlargements) defining a common support plane in the manner of small beams capable of optionally supporting a holding element resting thereon. The holding element can comprise horizontal, radially arranged hook-shaped grippers, into which plant shoots can be inserted in the close-up range above the root center.

The connection adapter can comprise a holding element having a plurality of, preferably four, hook-shaped grippers and a plurality of, preferably four, openings as well as a substantially cruciform central recess. The recess is adapted for receiving the connection adapter and the rod in a manner protruding therethrough.

On the substantially H-shaped members of the connection adapter (adapter module), preferably on their opposite outer longitudinal sides, step-like enlargements are formed at the same level terminating at a common level. Optionally, these step-like enlargements can horizontally support a holding element having a substantially cruciform recess at its center. This recess is dimensioned such that it is penetrated by the limbs and the rod cooperatively supported by them and is held by the steps. The holding element preferably includes four radially arranged hook-shaped grippers, the openings of which are located close to the rod and via which plant shoots can be introduced which can engage in the inner extensions of the holding element due to their inherent tension.

In a further embodiment, the plant support frame for supporting plants comprises a rod attachment for supporting at least one plant vessel adapted for receiving an elongate vertically adjustable rod and at least one plant vessel. Also this rod attachment comprises a substantially H-shaped attachment member having a first slot, a first recess and a first connecting web formed between the first slot and the first recess. The first recess is laterally defined by two first substantially parallel limbs, wherein the first limbs are connected to each other by the first connecting web, and wherein the first slot and the first recess extend from the first connecting web in opposite directions.

Moreover, the rod attachment for supporting the plant vessel comprises a substantially U-shaped attachment member having a second recess and a second slot extending therefrom, wherein the second recess is laterally defined by two second substantially parallel limbs connected to each other by a second connecting web.

Both, the H-shaped attachment member and the U-shaped attachment member of the rod attachment for supporting plant vessels are preferably flat in shape. The H-shaped attachment member is adapted for attachment to the first end of the rod. The U-shaped attachment member is attached to the H-shaped attachment member in a crosswise manner relative to the H-shaped attachment member so that the first slot engages the second slot. The two first limbs and the two second limbs form a first enclosure so that the rod can be firmly locked at its periphery in this first enclosure by the first and second limbs.

The H-shaped attachment member and/or the U-shaped attachment member of the rod attachment for supporting plant vessels each comprise at least two arcuate supporting arms extending laterally from the first and second connecting webs, which supporting arms, in the assembled state, form a further enclosure for the plant vessel to be supported. Displacement of the plant vessel in at least one first horizontal direction is thus limited by the supporting arms.

In one variant, both the H-shaped attachment member and the U-shaped attachment member can comprise two supporting arms so that displacement of the plant vessel to be supported is limited in two horizontal directions perpendicular to each other.

In a further embodiment, the plant support frame further comprises at least two supporting arcs each having a base and two respective supporting limbs extending from the base. A further slot is formed in the area of the base of the supporting arcs and in each one of the supporting arms of the U-shaped attachment member. Slots can also be formed in the supporting arms of the H-shaped attachment member.

In addition, one extension each is formed in the U-shaped attachment member and in the H-shaped attachment member in the area of the first and second connecting webs on a side opposite to the respective recess. The slot of each supporting arc engages a respective one of the slots formed in the supporting arms. The supporting arcs can be attached/stuck to the respective supporting arm, for example, in a crosswise manner relative to the respective supporting arm. All in all, the supporting arcs, the supporting arms and the extensions collectively form two enclosures. A plant vessel to be supported can be received in each one of the two enclosures, wherein displacement thereof is limited in two directions perpendicular to each other.

A plant support frame system comprises at least one plant support frame and two or more identical flat foot straps. In application, the foot straps are positioned on their longitudinal edges and arranged in an intersecting manner. The foot straps comprise vertical slots at their intersections. The intersecting foot straps engage each other at said slots. Optionally, one plant support frame each can be attached at/stuck to one of the intersections or a plurality of intersections.

By means of the foot straps, the system meets the specific situation of roof gardens, the earth fill of which is rarely sufficient for fixing rods. The specific feature being that the statically effective platform is increased by an interconnected lattice structure, the dimensions of which are arbitrarily expandable, prior to substrate application. For this purpose, the ribbon-shaped foot straps uniform in width and having equally spaced insertion slots on one side extending up to the center thereof are assembled in an upright, perpendicular and intersecting manner and placed onto the ground area. Each one of their intersection points offers the option to bring a rod into a vertical position. This can be achieved either by connection adapters being identical to those used for elongating the standard rod, or by limbs rising up at each intersection point on all sides which, in a group of four in each case, fix the rod in the vertical direction in a manner analogous to the solitary foot member.

The above-described plant support frame or the above described plant support frame system can advantageously be used for locating and marking a plant or a plurality of plants during the dormancy period. Advantageously, a label is positioned on the holding element. A label can be positioned on the holding element. The label can comprise a clamping portion adapted for partially encompassing the rod and can be attachable to the rod and removable from the rod. A frame member movable in height above the label can rest thereon.

Outdoors, during the dormancy period of retracted bushes, it can be useful to leave the rod in place, even though it is then not required as a trellis, in order to maintain the once determined most favorable height for applying the trellis attachments for the next season.

The basic principle of the single rod for primary gaining of height can then be utilized such that this rod is not used as a marking of the place only, in which a retracted bush or sowing is located, but takes over the task of a label support using holding elements possibly adapted for this purpose, which allows identification thereof even when not visible. This use of the trellis as a label support during the dormancy period has the further advantage of making the rod better visible by means of the required attachment module since it, as a only narrow vertical element, might be easily overlooked in the planting bed and thus become a danger during tending works.

The plant support frame according to the invention thus comprises flat, i.e. substantially two-dimensional, shaped members having a predetermined material thickness. These shaped members are the holding elements, H- and U-shaped attachment members, foot and connecting members, foot straps, etc. described herein. These flat shaped members are preferably stuck to each other, however, can alternatively also be firmly connected, e.g. screwed or welded or adhered to each other.

The shaped members are assembled in a crosswise manner in the area of their slots which are formed reciprocally, i.e. complementary to each other, in the pair of shaped members which can be assembled. In the assembled/stuck together state, the shaped members form modules, such as the rod attachment (rod cap), the connection adapter or modules for mere gaining of height, decorative endings or the foot.

Optionally, all modules which, in combination, enable a demand-oriented trellis solution can be stuck (attached) to each other, for example, rod attachments having radial labyrinth-like structured holding elements can be vertically expanded among themselves by attachment. The modules are stuck to each other offset by 45 degrees so that the four lower limbs of the upper module (e.g. of the rod attachment) reach down into the four intersection angles of the lower assembled shaped member (e.g. a module for gaining height) in an accurately fitting manner.

Advantageously, such an arrangement of the assembled shaped members, due to the, in effect, eight radially adjacent structures reinforcing each other in a lamellar way, provides particularly high stability of the plant support frame even in the case of repeated stacked use of modules with large radial holding elements.

In outdoor use, the basic principle of separate handling of the supporting rod and the modules enables the first step of adequate height adjustment of the trellis. Due to an assortment of predetermined standard lengths of rods, the user is spared the effort of cutting, since the first coarse height determination results from the drive-in depth of a rod into the soil, wherein the rod is possibly driven deeper into the soil than required for reasons of statics. Furthermore, the plant support frame according to the invention offers all required possibilities for readjustment of the height of the holding elements. This is achieved either by the internal design of the module itself conceived for this purpose, or by modules for vertical gaining of height, or by the connecting adapters which, by means of additional upper rod recesses, enable elongation of the rod by a rod portion.

The invention is described by way of example by reference to the attached figures in the following, wherein:

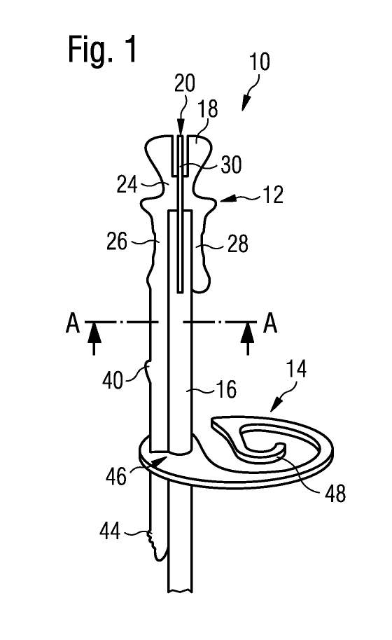

FIG. 1 shows a schematic view of a first embodiment of a plant support frame according to the invention, wherein the rod is firmly locked at its periphery by the first and second limbs;

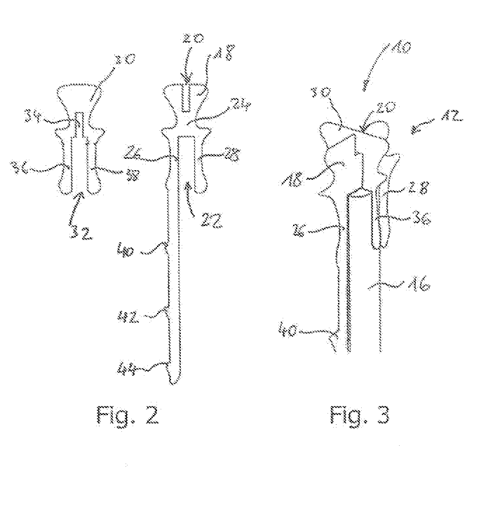

FIG. 2 shows a side view of the H-shaped and U-shaped attachment members of FIG. 1;

FIG. 3 shows a perspective detailed view of an upper portion of the plant support frame of FIG. 1;

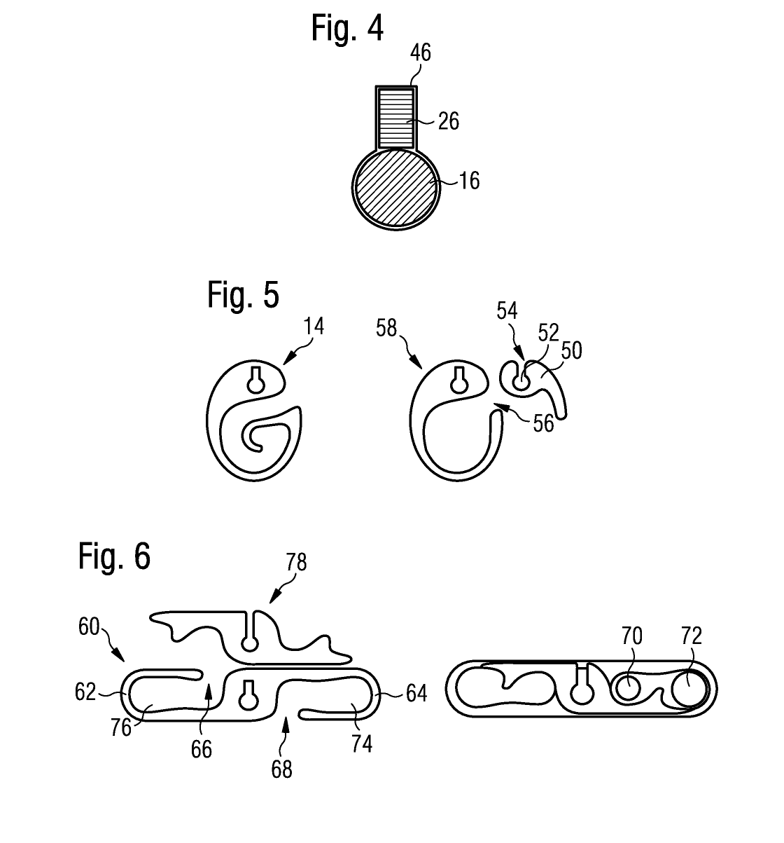

FIG. 4 shows a cross-sectional view of the plant support frame along plane A-A illustrated in FIG. 1;

FIG. 5 shows a view of a hook-shaped holding element and an eyelet-shaped holding element;

FIG. 6 shows a view of a holding element in an open state and a closed state;

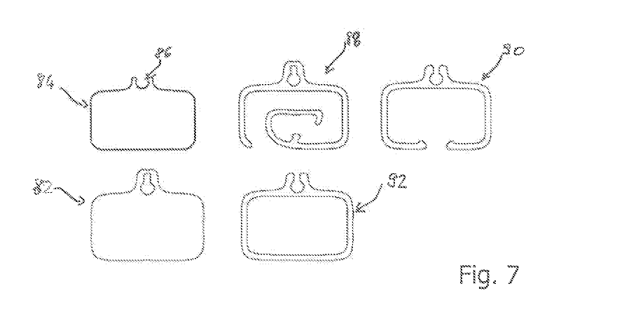

FIG. 7 shows a view of various holding elements for solitary plant shoots and labels;

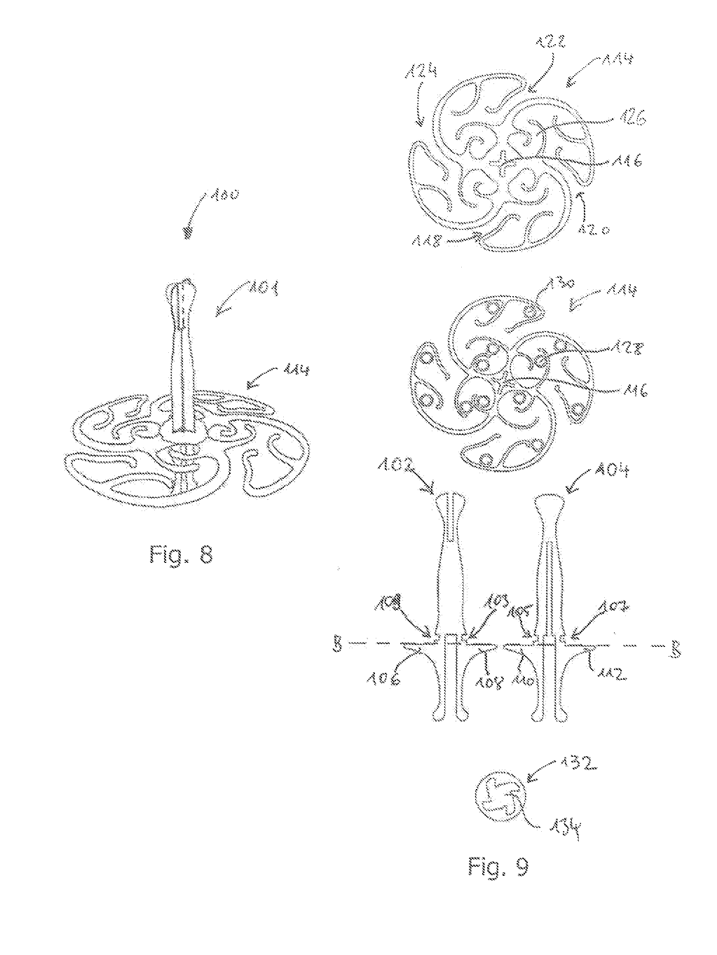

FIG. 8 shows a perspective view of a second embodiment of a plant support frame according to the invention;

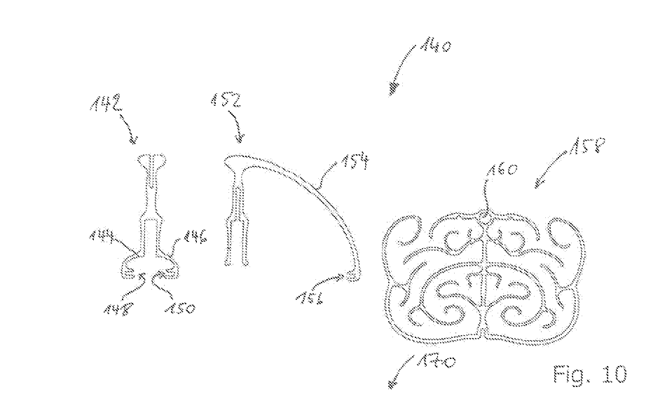

FIG. 9 shows a top view of the components of the plant support frame of FIG. 8;

FIG. 10 shows a top view of the components of a third embodiment of a plant support frame according to the invention;

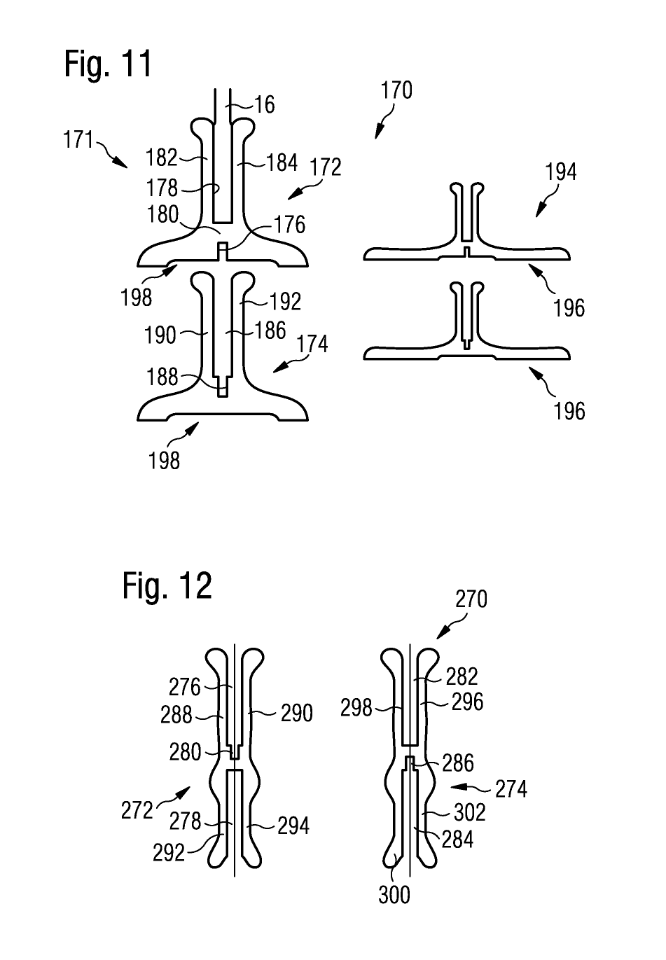

FIG. 11 shows a side view of the components of a fourth embodiment of a plant support frame according to the invention;

FIG. 12 shows a side view of the components of a fifth embodiment of a plant support frame according to the invention;

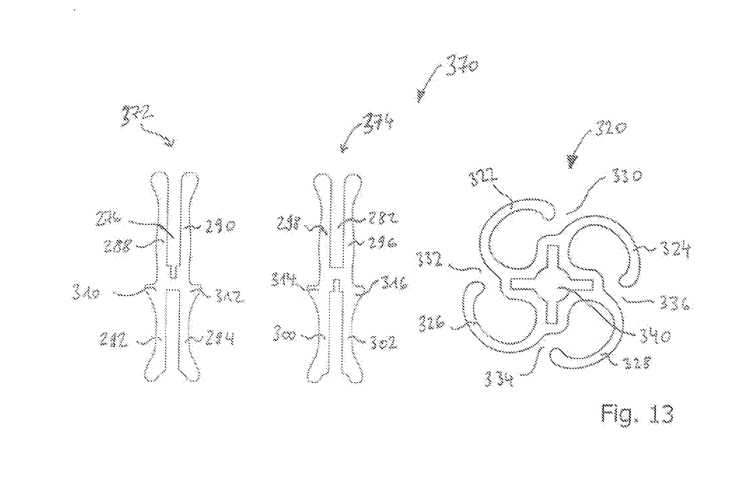

FIG. 13 shows a side or top view of the components of a sixth embodiment of a plant support frame according to the invention;

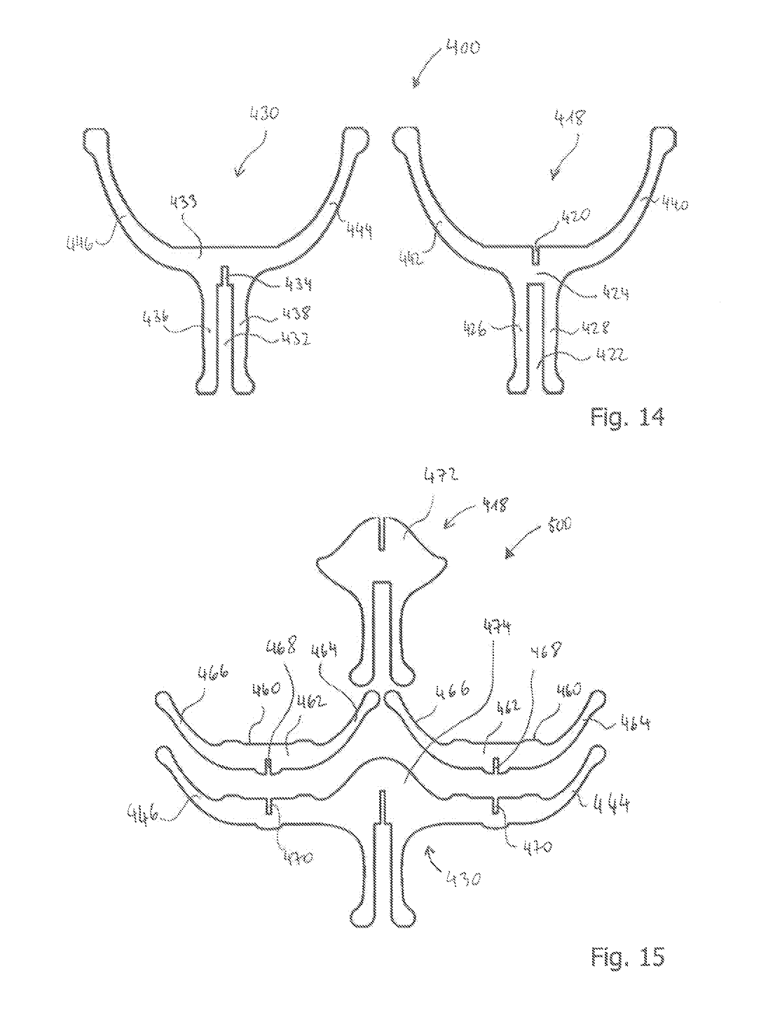

FIG. 14 shows a side view of the components of a seventh embodiment of a plant support frame according to the invention;

FIG. 15 shows a side view of the components of an eighth embodiment of a plant support frame according to the invention.

FIGS. 1 to 3 show a first embodiment of a plant support frame 10 (plant rack) for supporting plants according to the invention. The plant support frame 10 comprises a rod attachment 12 supporting a flat holding element 14 and receiving an elongate vertically adjustable rod 16. The rod attachment 12 comprise a substantially H-shaped attachment member 18 having a first slot 20, a first recess 22 and a first connecting web 24 formed between the first slot 20 and the first recess 22. The first recess 22 is laterally defined by two first substantially parallel limbs 26, 28. The first limbs 26, 28 are connected to each other by the first connecting web 24, and the first slot 20 and the first recess 22 extend from the first connecting web in opposite directions.

The rod attachment 12 further comprises a substantially U-shaped attachment member 30 having a second recess 32 and a second slot 34 extending therefrom, wherein the second recess 32 is laterally defined by two second substantially parallel limbs 36, 38.

Both, the H-shaped attachment member 18 and the U-shaped attachment member 30 are flat in shape. As shown in FIGS. 1 and 3, the H-shaped attachment member 18 is attached to a first end of the rod 16, and the U-shaped attachment 30 is attached to the H-shaped attachment member 18 in a crosswise manner relative to the H-shaped attachment member 18. The first slot 20 then engages the second slot 34, wherein the two first limbs 26, 28 and the two second limbs 36, 38 form a first enclosure. The rod 16 is firmly locked at its periphery in this first enclosure by the first and second limbs 26, 28, 36, 38.

Spaced apart steps 40, 42, 44 are formed on the limb 26 of the H-shaped attachment member 18. As shown in FIG. 4, the holding element 14 comprises a keyhole-like recess 46, through which the rod 16 and the limb 26 protrude, thereby holding the holding element 14 horizontally. In the illustration, the holding element 14 rests on the middle step 42. Plant shoots can be fixed to the plant support frame 10 by means of a hook-shaped portion 48 formed on the holding element 14.

FIGS. 5 and 6 show the holding element 14, an eyelet-shaped holding element 58 and a closing element 50 provided for the holding element 58 and adapted for resting on the holding element 58. The closing element 50 also comprises a keyhole-like recess 52 which, however, differs from the recess 46 of the holding element 14 in that it is open 54 towards the outer contour on one side and is thus vertically displaceable across the steps 40, 42, 44 along the rod 16 and along the limb 26 and is held by the limb 26 in a torque-proof manner, wherein the closing element 50 closes off the opening 56 in the contour of the holding element 58. By means of the closing element 50, an eyelet is formed which fixes the plant shoot in a manner safe from loss even in an exposed position with wind from changing directions.

A holding element 60, which can be used instead of the holding element 14, comprises two hooks 62, 64, through the openings 66, 68 of which plant shoots 70 and 72 can be introduced into recesses 74, 76 of the holding element 14. A matching closing element 78 displaceable in height has a shape complementary to the holding element 60 which, in addition, allows separating the shoots spatially from each other.

Further holding elements provided for the plant support frame 10 are shown in FIG. 7.

The hook-shaped holding element 88 fulfills the double function of being capable of serving as a holder for a plant shoot on the one hand and, alternatively thereto, during the dormancy period, acting as an accurately fitting support for a label 84, which can be fixed by an element 90 or 92 displaceable in height and resting thereon in the closed state. Element 90 and the eyelet-shaped element 92 can be used for fixing the label (element 84) by weighting the label at its periphery or locking it by resting on its periphery. Element 84 is made of a thin, elastic and inscribable label material and, due to its configuration 86 marginally encompassing the supporting rod, comprises an opening enabling pre-fixing the label to the rod and replacing it when required without the need for disassembling the entire module.

Holding element 82 is provided as an alternative to the label 84 or as an alternative to the label support of the formally adapted holding element 88. When used as an alternative to label 84, it is configured as an inscribable plate. This plate comprises the same keyhole-like recess than the holding element 14. Element 82 can also be used as a non-inscribable, stable support for the label 84 as an alternative to the holding element 88 when employed according to its secondary use.

FIGS. 8 and 9 show a second embodiment of a plant support frame 100 according to the invention, wherein the H-shaped attachment member 102 and the U-shaped attachment member 104 each comprise two horizontal beams 106, 108 and 110, 112. The beams define a support plane B and cooperatively support a holding element 114 in the support plane B. The rod attachment 101 penetrates the holding element 114 in the area of a central cruciform recess 116.

In its outer contour, the holding element 114 comprises openings 118, 120, 122, 124 to labyrinth-like recesses 126 of the holding element 114, and the labyrinth-like recesses 126 of the holding element are adapted for captively retaining parts of plant shoots 128, 130. Furthermore, a ring 132 comprises a cruciform recess 134. This recess 134 enables screwing and engaging the ring 132 on the holding element 114 resting on the beams 106, 108 and 110, 112 (cf. FIG. 8). The ring 132 is thus fixed in its final position by means of slight tension. Thus, it is possible that the holding element 114 cannot be tilted from the horizontal by weights resting thereon on one side or in a storm.

The holding element itself is horizontally fixed by a ring having a cruciform recess, the contour of which is sufficient in size in a horizontal rotational position to be penetrated by the assembled attachment members so that the ring can be centrally applied to the holding element and its four inwardly increasingly broadening wings can be moved, by means of rotation, into accurately fitting recesses of the attachment members until it is engaged in its final position by means of slight tension.

Furthermore, the plant support frame 100 comprises all features of the plant support frame 10.

A third embodiment of a plant support frame 140 according to the invention is shown in FIG. 10 by means of separate individual components. In the plant support frame 140, the H-shaped attachment member 142 comprises a first limb 144 elongated in an arcuate manner and a second limb 146 elongated in an arcuate manner being symmetrical thereto with respect to a central axis of the H-shaped attachment member, and the U-shaped attachment 152 comprises an arcuate elongation 154. At their distal ends, all elongated limbs 144, 146 and the arcuate elongation 154 each comprise a fork-like gripping device 148, 150, 156 with an opening facing the rod.

The holding element 158 is supported by these gripping devices 148, 150, 156. The holding element 158 comprises a hole 160, in which the rod 16 is received in a manner protruding therethrough, so that the holding element 158 is stabilized.

Furthermore, the plant support frame 100 comprises all features of the plant support frame 10.

A fourth embodiment of a plant support frame 170 according to the invention is shown in FIG. 11 by means of separate individual components. The plant support frame 170 differs from plant support frame 10 in that it comprises a foot 171 for supporting the rod 16 in a vertical orientation. This variant is intended for subsurface use, e.g. in the field of tub plants, where the resistance of the soil alone is too low to ensure a permanent vertical position of the rod, or it is used on planar ground for plant trellises for raised support of hanging basket plants. The foot 171 comprises a substantially H-shaped foot member 172 having a third slot 176, a third recess 178 and a second connecting web 180 formed between the third slot 176 and the third recess 178, wherein the third recess 178 is laterally defined by two third substantially parallel limbs 182, 184, wherein the third limbs 182, 184 are connected to each other by means of the second connecting web 180, and wherein the third slot 176 and the third recess 178 extend from the second connecting web 180 in opposite directions.

The foot 171 further comprises a substantially U-shaped foot member 174 having a fourth recess 186 and a fourth slot 188 extending therefrom, wherein the fourth recess 186 is laterally defined by two fourth substantially parallel limbs 190, 192. The H-shaped foot member 172 and the U-shaped foot member 174 are flat in shape and the H-shaped foot member 172 is attached to a second end of the rod 16. The U-shaped foot member 174 is attached to the H-shaped foot member 172 in a crosswise manner relative to the H-shaped foot member so that the third slot 176 engages the fourth slot 188. The two third limbs 182, 184 and the two fourth limbs 190, 192 form a second enclosure and the rod is locked at its periphery in this second enclosure by the third and fourth limbs 182, 184 and 190, 192.

Furthermore, FIG. 11 shows a foot 194 which differs from foot 171 in that the base 196 of the foot 194 is longer and wider than the base 198 of foot 171. For manufacturing reasons, the slight central lower recess spans elevations of planters made of plastic material often located in this position.

Furthermore, the plant support frame 170 comprises all features of the plant support frame 10.

A fifth embodiment of a plant support frame 270 according to the invention is shown in FIG. 12 by means of separate individual components. The plant support frame 270 differs from plant support frame 10 in that it additionally comprises a connection adapter formed of a first and a second substantially H-shaped connecting member 272, 274. The first H-shaped connecting member 272 comprises a fifth and a sixth recess 276, 278 and a fifth slot 280, and the second connecting member 274 comprises a seventh and an eighth recess 282, 284 and a sixth slot 286. The fifth recess 276 is laterally defined by two substantially parallel fifth limbs 288, 290, the sixth recess is laterally defined by two substantially parallel sixth limbs 292, 294, the seventh recess is laterally defined by two substantially parallel seventh limbs 296, 298, and the eight recess is laterally defined by two substantially parallel eighth limbs 300, 302.

The first and second H-shaped connecting members 272, 274 are illustrated as being symmetrical with respect to a common central axis of symmetry and the first and second H-shaped connecting members 272, 274 are adapted for crosswise assembly, wherein the second H-shaped connecting member 274 is attached to the first H-shaped connecting member 272 in a crosswise manner relative to the first H-shaped connecting member so that the fifth slot 280 engages the sixth slot 286.

The two sixth limbs 292, 294 and the two eighth limbs 302, 304 form a third enclosure and the rod (not shown) is to be firmly locked in this third enclosure. Furthermore, the two fifth limbs 288, 290 and the two seventh limbs 296, 298 form an additional enclosure so that an additional rod (not shown) can be locked at its periphery by means of the fifth and seventh limbs.

Furthermore, the plant support frame 270 comprises all features of plant support frame 10.

A sixth embodiment of a plant support frame 370 according to the invention is shown in FIG. 13 by means of separate individual components. The plant support frame 370 differs from plant support frame 270 in that the connection adapter of the plant support frame 370 comprises step-like enlargements 310, 312, 314, 316.

The connection adapter of the plant support frame 370 comprises a holding element 320 having four hooks 322, 324, 326, 328 and four openings 330, 332, 334, 336 as well as a substantially cruciform central recess 340. The recess is adapted for receiving the connection adapter and the rod in a manner protruding therethrough.

On the substantially H-shaped members of the connection adapter (adapter module) of the plant support frame 270, preferably on their opposite outer longitudinal sides, step-like enlargements 310, 312, 314, 316 are formed at the same level terminating at a common level and are thus optionally suitable for horizontally supporting a holding element 320 having a substantially cruciform recess 340 at its center. This recess 340 is dimensioned such that it is penetrated by the limbs 288, 290, 296 and 298 and the rod cooperatively supported by them and is held by the steps 310, 312, 314, 316. The holding element 320 preferably includes four radially arranged hook-shaped grippers 322, 324, 326, 328, the openings 330, 332, 336, 338 of which are located close to the rod and via which plant shoots can be introduced which can engage in the inner extensions of the holding element due to their inherent tension.

Furthermore, the plant support frame 370 comprises all features of plant support frame 270.

A seventh embodiment of a plant support frame 400 according to the invention is shown in FIG. 14 by means of separate individual components. This plant support frame 400 comprises a rod attachment for supporting at least one plant vessel adapted for receiving an elongate vertically adjustable rod (not shown) and at least one plant vessel (not shown).

This design complies with the growth behavior of plants with hanging shoots by enabling elevated stormproof outdoor placement of the planter in an arbitrary distance from the ground. In the case of ornamental plants for aesthetic reasons, in the case of crop plants additionally or predominantly for increasing the crop yield, it can be useful to arrange the drooping shoots radially around the rod holding the vessel. This is achieved by interposing the module described in FIG. 8.

The rod attachment comprises a substantially H-shaped attachment member 418 having a first slot 420, a first recess 422 and a first connecting web 424 formed between the first slot 420 and the first recess 422. The first recess 422 is laterally defined by two first substantially parallel limbs 426, 428 connected to each other by the first connecting web 424. The first slot 420 and the first recess 422 extend from the first connecting web 424 in opposite directions.

The rod attachment further comprises a substantially U-shaped attachment member 430 having a second recess 432 and a second slot 434 extending therefrom, wherein the second recess 432 is laterally defined by two second substantially parallel limbs 436, 438 connected to each other by a second connecting web 433. The H-shaped attachment member 418 and the U-shaped attachment member 430 are flat in shape. The H-shaped attachment member 418 is adapted for attachment to the first end of the rod 16, and the U-shaped attachment member 430 is attached to the H-shaped attachment member 418 in a crosswise manner relative to the H-shaped attachment member 418 so that the first slot 420 engages the second slot 434, wherein the two first limbs 426, 428 and the two second limbs 436, 438 form a first enclosure so that the rod can be firmly locked at its periphery in this first enclosure by the first and second limbs. The H-shaped attachment member and the U-shaped attachment member each comprise at least two arcuate supporting arms 440, 442, 444, 446 extending laterally from the first and second connecting webs 424, 433, which supporting arms, in the assembled state, form a further enclosure, in which the plant vessel to be supported is received. Displacement of the plant vessel in at least two horizontal directions perpendicular to each other is limited by the supporting arms 440, 442, 444, 446. Instead of a plant vessel, a battery or solar-cell powered translucent lamp can also be inserted into the enclosure for illuminating the garden in the evening.

An eighth embodiment of a plant support frame 500 according to the invention is shown in FIG. 15 by means of separate individual components. This plant support frame 500 differs from plant support frame 400 in that the H-shaped attachment member 418 does not comprise any supporting arms, rather only the U-shaped attachment member 430 comprises two supporting arms 444, 446.

The plant support frame 500 further comprises two supporting arcs 460 having a base 462 and two respective supporting limbs 464, 466 extending from the base 462, wherein a further slot 468 is formed in the area of the base 462 of the supporting arcs 460 in each case. In addition, a further slot 470 is formed in each one of the supporting arms 444, 446 of the U-shaped attachment member. One extension 472, 474 each is formed in the U-shaped attachment member 430 and in the H-shaped attachment member 418 in the area of the first and second connecting webs on a side opposite to the respective recess, wherein the slot 468 of each one of the supporting arcs 460 engages a respective one of the slots 470 formed in the supporting arms so that the supporting arcs 460, the supporting arms 444, 446 and the extensions 472, 474 collectively form two enclosures.

At least one plant vessel can be received in each one of the two enclosures. Displacement of a plant vessel to be supported received therein is thus limited in two directions perpendicular to each other, especially due to the supporting arcs 460, the supporting arms 444, 446 and the extensions 472, 474.

Alternatively, the rod attachments of the plant support frames 400 and 500 can be used as feet analogous to the feet 171 and 194. The supporting arms 444, 446 and optionally the supporting arcs 460 and/or the extensions 472, 474, especially their ends opposite to the enclosure of the rod, then stand on a support surface and hold the rod in a vertical orientation.

The plant support frame according to the invention can further comprise one or more of the following features:

The plant support frame (plant rack) according to an attachment system can be particularly suitable for prophylactic or reconstructive fixing of standing and hanging instable shoots of any outdoor or tub plants in their respective individual natural habitus. The plant support frame can have a supporting function, for example for supporting hanging basket plants with their planters or for supporting other objects belonging to the plant resting thereon, for example the fruit thereof, or objects sustaining the plant, such as evaporation vessels, or additional planters for reproduction by layers. Outdoors, during the dormancy period, the plant support frame can be temporarily used as a position marker and label support for identifying retracted bushes not in need of support or not yet developed sowing as information for useful coordination of horticultural measures in the surroundings.

Apart from a single rod for primary gaining of height fixed in the soil or by means of tools independently of the modules to be applied thereto afterwards, the plant support frame may exclusively consist of members, the final production of which merely requires knowledge of the two-dimensional contours thereof and the standard material thickness, and of which members a respective lower member and a respective upper member can be vertically assembled (plugged, stuck together) in a crosswise manner at right angles by means of reciprocal slots to form modules. The modules can be the rod attachment (rod cap), the connection adapter, the foot, modules for gaining height or protective and decorative endings. The modules can hold the rod from four sides in a vertical position by means of an accurately fitting recess and/or be seated on the rod, according to this principle, in a manner adapted in function. Further members can be fixed to the modules in a horizontal position, which members can comprise openings in their outer contours for introducing plant shoots, which openings lead to inner recesses determining a vertical end position of the shoots, wherein additional modules can be attached to the vertical pair of members in a demand-oriented manner so that the ending of their lower recess sits on the highest intersection point of the vertical shaped members of the lower module and their four limbs reach down into the four angles of the lower member in a fitting (abutting) manner.

The plant support frame can further comprise a uniformly narrow elongation of the lower vertical attachment member of the module accompanying the rod supporting this module downwards in a contacting manner. The lower vertical attachment member can be the H-shaped attachment member or the H-shaped connecting member. The elongation can be provided with enlargements at predetermined intervals, which are alternatively available as locking devices, horizontally fixing holding elements, which are formed as inwardly retracting hook-shaped grippers for receiving plant shoots, to the rod at a desired level due to the fact that they comprise a bore accurately fitting in shape, through which the elongation can be moved together with the resistances and which is filled by parallel insertion of the rod in such a way that the respective locking device below the holding element becomes effective, since there is room for only one of the narrow portions of the vertical elongation next to the rod in the perpendicularly terminating area of the bore, wherein the rod, in turn, completely fills the area of the bore adapted to its cross-section.

At the plant support frame, a second horizontal member, for example a closure element, can rest on a horizontal member, for example a holding element, which second horizontal member can be freely moveable in the vertical direction across the locking protrusions of the elongation of the lower vertical shaped member, but can be fixed to the rod in the horizontal by means of a partial undercut. The horizontal members can each be adapted not to rotate autonomously about the rod due to the guiding by the elongation of the lower vertical shaped member. The second horizontal member can further be formed such that it closes off lateral openings to inner recesses of the lower member already by resting thereon. The second horizontal member itself can be open in positions on its outer contour and enable lateral introduction of plant shoots so that both members, in cooperation, provide for a ring or loop-like complete horizontal fixation of shoots. In addition, the member resting on top can provide a further inner fixation corresponding to the shoot thickness by means of constrictions of the common central openings.

During the dormancy period of a bush or during early stages of development of sowing, the plant support frame may alternatively not be used as a support but, since the plant is either retraced or not yet developed and thus invisible, for localization thereof. Until it reassumes its plant-support function, the plant support frame can serve as a label support and thus as an information carrier for the associated plant so that horticultural measures in the surroundings can be reasonably coordinated. In this case, a label made of elastic material, for example of PCV, can be attached to the plant support frame and held in position by resting on or being adhered to the lower holding element, i.e. the gripper, which may possibly be formally adapted but unimpaired in its functionality.

Optionally, the label resting on the lower holding element can be weighted at its non-inscribed edges by a matching frame-like holding element resting thereon, which may comprise an opening for receiving a plant shoot, and can additionally be fixed by means of an accurately fitting recess in the peripheral area partially encompassing the supporting rod such that effects caused by weather will not move the label out of its position when the holding element rests thereon. It may further be provided that the lower holding element serves as a support for an elastic label, which can be horizontally removed from its anchoring to the rod with a minimum amount of force when the upper holding element is raised, and can be replaced by another one by the inverse process by horizontally attaching the latter to the rod. The members of the trellis can be reused for supporting plant shoots when needed.

The lower holding element, i.e. the gripper, can be temporarily replaced by a continuous surface mounted according to the same principle, which surface is itself inscribable or serves as a support for a label made of elastic material, for example of PVC, and can be weighted, for safeguarding purposes, by a cartridge-like framing holding element resting thereon and having a closed peripheral contour.

The vertical members can be extended towards all sides by beams terminating horizontally in an upward direction in a horizontal plane and can cooperatively support a horizontal element in the assembled (i.e., stuck together) state which, on the one hand, comprises a central cruciform recess having a dimension which is necessary and sufficient to be penetrated by the portion of the vertical members rising above the beams. In its outer contour, the horizontal element can comprise inlets to branched systems of continuous recesses spontaneously changing directions, which enable engagement of plant shoots in various locations of this internal configuration.

The two limbs of the lower vertical shaped member defined by the recess for the rod can be extended in a downward direction in a manner leading away from the rod at an increasing distance and comprise spontaneous constrictions in their enlarged end portions. These constrictions can be located at the same level as an identical constriction functionalizing the end portion of a bow emanating from the upper vertical shaped member and spanning a holding element mounted in the three constrictions. This holding element is additionally secured against horizontal movement by the fact that the supporting rod, on the one hand, is guided through a corresponding accurately fitting bore and, on the other hand, comprises spontaneous constrictions in the area of confrontation of vertical and horizontal which are dimensioned in an accurately fitting manner to fittingly encompass the supporting vertical shaped members from three sides in a fork-like manner, and the inner contour of which comprises a branched system of interconnected recesses. This system, in turn, comprises outlets in its outer contour for receiving standing and hanging plant shoots and is suitable, in its capacity as a surface standing horizontally in space, for supporting vessels of plants, the drooping shoots of which can be loosely threaded into the supporting surface and thus be fixed in their vertical appearance.

The resistance of the soil enabling the vertical positioning of the trellis outdoors can be replaced by two vertical shaped members perpendicularly intersected by means of reciprocal slots, said shaped members comprising an accurately fitting recess for the rod in a vertical upward direction above their intersection axis and being characterized by a common planar horizontal base. This base is provided for standing on a planar surface, e.g. on the bottom of a planter, below the surface in the root area. The commonly occurring central elevations in the bottom of plastic vessels can be spanned by central recesses below the intersection point of the thus constructed foot. An alternative use of this foot at outdoor use on the free rod end provides for, when standing on firm ground, using a second foot inversely applied to the upper rod end for enabling support of a planter with a hanging basket plant at a height above the ground adapted to its drooping shoots or corresponding to the desired visual appearance.

On a larger surface having a low earth fill, the plant support frame, without being mounted to the ground surface in any way, can enable vertical support of instable shoots of a plurality plants growing at a distance from each other by means of individual trellises in a manner possible as in comparable open areas having a meters thick layer of earth. A lattice system infinitely expandable by perpendicular intersections is located at the subsurface level. The individual components of the lattice system are composed of stable strap configurations of uniform thickness and height, but differing in length, positioned on a longitudinal edge. On a longitudinal side, the strap configurations comprise equidistant vertical slots having a width slightly exceeding the material thickness.

Preferably, the slots extend up to the center of the strap, where they terminate at right angles and can thus be combined among themselves in a manner assembled vertically at right angles such that the bases of the upward slots of the respective lower strap located in the center of the strap are contacted by the respective bases of the slots of the strap used in a manner resting thereon. The intersection point located in places in need of a plant trellis can be spanned by a module consisting of two vertical members assembled by means of a reciprocal slot. Thereby, it is provided that the members rest on the intersection point such that the common base of a lower recess rests thereon, which recess is dimensioned such that it is just sufficient to allow the limbs defining it to project downwards diagonally into the angles of the intersection, and to which limbs limb configurations on the upward side correspond, the limb configurations having a common recess which is dimensioned for accurately fitting the rod to be vertically received. These modules can thereby also fulfil the function of prolonging a rod of a matching thickness (or diameter) by a corresponding rod part.

The vertical rod for primary gaining of height can be extended by a rod portion not necessarily equal in thickness (or diameter) by means of an adapter module. The adapter module can be the connection adapter. The adapter module can consist of two vertical members which, in addition to the lower recess, comprise an upper recess identical in function. The upper recess can be aligned axially symmetrically with the same vertical linewith respect to which the reciprocal attachment slots and the lower recesses are axially symmetrically oriented. The upper recess can be sized such that, instead of a rod, a diagonally inserted vertical module can fulfill various functions in a statically stable manner, even if it is not provided with a lower recess itself.

1-13. (canceled)

14. A plant support frame for supporting plants, comprising a rod attachment for supporting flat holding elements adapted for receiving an elongate vertically adjustable rod, said rod attachment comprising:
a substantially H-shaped attachment member having a first slot, a first recess and a first connecting web formed between the first slot and the first recess, wherein the first recess is laterally defined by two first substantially parallel limbs, wherein the first limbs are connected to each other by means of the first connecting web, and wherein the first slot and the first recess extend from the first connecting web in opposite directions; and
a substantially U-shaped attachment member having a second recess and a second slot extending therefrom, wherein the second recess is laterally defined by two second substantially parallel limbs;
wherein the H-shaped attachment member and the U-shaped attachment member are flat in shape; and
wherein the H-shaped attachment member is adapted for attachment to a first end of the rod, and the U-shaped attachment member is attached to the H-shaped attachment member in a crosswise manner relative to the H-shaped attachment member so that the first slot engages the second slot, wherein the two first limbs and the two second limbs form a first enclosure so that the rod is firmly locked at its periphery in this first enclosure by the first and second limbs.

15. The plant support frame according to claim 14, wherein spaced apart steps are formed on one of the limbs of the U-shaped attachment member or the H-shaped attachment member, wherein the holding elements rest on said steps, and the holding elements each comprise one recess adapted for receiving the rod and the limb in a manner protruding therethrough, thereby holding the holding elements horizontally, and wherein the holding elements comprise one or more hook-shaped portions for fixing parts of plant shoots.

16. The plant support frame according to claim 15, wherein a closing element rests on a holding element, which closing element is vertically displaceable across steps along the rod and along the limb and is held by the limb in a torque-proof manner, wherein the closing element closes off openings in the contour of the holding element.

17. The plant support frame according to claim 14, wherein the holding element is shaped as a plate, which is inscribable or serves as a support for a label, wherein a frame member peripherally encompassing the holding element rests on the label in a fixing manner, wherein the label is elastic and adapted for attachment to the rod.

18. The plant support frame according to claim 14, wherein the H-shaped attachment member and the U-shaped attachment member each comprise two horizontal beams, which define a support plane and cooperatively support a holding element in the support plane, wherein the rod attachment penetrates the holding element in the area of a central cruciform recess, the holding element, in its outer contour, comprises openings to labyrinth-like recesses of the holding element, and the labyrinth-like recesses of the holding element are adapted for captively holding parts of plant shoots, and wherein the holding element itself is horizontally fixed by a ring having a cruciform recess, the contour of which is sufficient in size in a horizontal rotational position to be penetrated by the assembled attachment members and so that the ring can be centrally applied to the holding element and its four inwardly increasingly broadening wings can be moved, by means of rotation, into accurately fitting recesses of the attachment members until it is engaged in its final position by means of slight tension.

19. The plant support frame according to claim 14, wherein the H-shaped attachment member comprises a first limb elongated in an arcuate manner and a second limb elongated in an arcuate manner being symmetrical thereto with respect to a central axis of the H-shaped attachment member, and the U-shaped attachment member includes an arcuate elongation, wherein all elongated limbs, at their distal ends, each comprise a fork-like gripping device with an opening facing the rod, which support a holding element.

20. The plant support frame according to claim 14, comprising a foot for supporting the rod in a vertical orientation, said foot comprising:
a substantially H-shaped foot member having a third slot, a third recess and a second connecting web formed between the third slot and the third recess, wherein the third recess is laterally defined by two third substantially parallel limbs, wherein the third limbs are connected to each other by means of the second connecting web, and wherein the third slot and the third recess extend from the second connecting web in opposite directions;
a substantially U-shaped foot member having a fourth recess and a fourth slot extending therefrom, wherein the fourth recess is laterally defined by two fourth substantially parallel limbs;
wherein the H-shaped foot member and the U-shaped foot member are flat in shape, and wherein the H-shaped foot member is adapted for attachment to a second end of the rod, and the U-shaped foot member is attached to the H-shaped foot member in a crosswise manner relative to the H-shaped foot member so that the third slot engages the fourth slot, wherein the two third limbs and the two fourth limbs form a second enclosure so that the rod is locked at its periphery in this second enclosure by the third and fourth limbs.

21. The plant support frame according to claim 14, comprising a connection adapter including a first and a second substantially H-shaped connecting member, wherein the first H-shaped connecting member comprises a fifth recess, a sixth recess and a fifth slot, and the second H-shaped connecting member comprises a seventh recess, an eighth recess and a sixth slot, wherein the fifth recess is laterally defined by two substantially parallel fifth limbs, the sixth recess is laterally defined by two substantially parallel sixth limbs, the seventh recess is laterally defined by two substantially parallel seventh limbs, and the eighth recess is laterally defined by two substantially parallel eighth limbs, wherein the inner contours of the first and second connecting members are symmetrical with respect to a common central axis of symmetry, and wherein the first and second connecting member are assembled in a crosswise manner, wherein the second H-shaped connecting member is attached to the first H-shaped connecting member in a crosswise manner relative to the first H-shaped connecting member so that the fifth slot engages the sixth slot, wherein the two sixth limbs and the two eighth limbs form a third enclosure so that the rod is firmly locked in this third enclosure, and wherein the two fifth limbs and the two seventh limbs form an addition enclosure so that an additional rod is firmly locked at its periphery by the fifth and seventh limbs, wherein the connection adapter comprises a holding element having a plurality of hook-shaped grippers and a plurality of openings as well as a substantially cruciform central recess, wherein the recess is adapted for receiving the connection adapter and the rod in a manner protruding therethrough, and wherein the first and second H-shaped connecting members comprise step-like enlargements adapted for supporting the holding element.

22. A plant support frame for supporting plants, comprising a rod attachment for supporting at least one plant vessel adapted for receiving an elongate vertically adjustable rod and at least one plant vessel, the rod attachment comprising:
a substantially H-shaped attachment member having a first slot, a first recess and a first connecting web formed between the first slot and the first recess, wherein the first recess is laterally defined by two first substantially parallel limbs, wherein the first limbs are connected to each other by the first connecting web, and wherein the first slot and the first recess extend from the first connecting web in opposite directions; and
a substantially U-shaped attachment member having a second recess and a second slot extending therefrom, wherein the second recess is laterally defined by two second substantially parallel limbs connected to each other by a second connecting web;
wherein the H-shaped attachment member and the U-shaped attachment member are flat in shape,
wherein the H-shaped attachment member is adapted for attachment to the first end of the rod, and the U-shaped attachment member is attached to the H-shaped attachment member in a crosswise manner relative to the H-shaped attachment member so that the first slot engages the second slot, wherein the two first limbs and the two second limbs form a first enclosure so that the rod is firmly locked at its periphery in this first enclosure by the first and second limbs; and
wherein the H-shaped attachment member and/or the U-shaped attachment member each comprise at least two arcuate supporting arms extending laterally from the first and second connecting webs, which supporting arms, in the assembled state, form a further enclosure for the plant vessel to be supported.

23. The plant support frame according to claim 22, wherein both the H-shaped attachment member and the U-shaped attachment member comprise two supporting arms for limiting displacement of the plant vessel to be supported in two horizontal directions perpendicular to each other.

24. The plant support frame according to claim 22, further comprising at least two supporting arcs having a base and two respective supporting limbs extending from the base;
wherein a further slot is formed in the area of the base of the supporting arcs in each case;
wherein a further slot is formed in each one of the supporting arms of the H-shaped attachment member;
wherein one extension each is formed in the U-shaped attachment member and in the H-shaped attachment member in the area of the first and second connecting webs on a side opposite to the respective recess; and
wherein the slot of each supporting arc engages a respective one of the slots formed in the supporting arms so that the supporting arcs, the supporting arms and the extensions collectively form two enclosures, wherein, in each one of the two enclosures, displacement of a plant vessel to be supported is limited in two directions perpendicular to each other.

25. A plant support frame system, comprising:
at least one plant support frame according to claim 14,
two or more identical flat foot straps, which are positioned on a longitudinal edge and arranged in a in intersecting manner, wherein the foot straps comprise vertical slots at their intersections, wherein the slots of intersecting foot straps engage each other, and wherein one plant support frame each is attached at one or more of the intersections.

26. A use of a plant support frame according to claim 14, for locating and marking a plant or a plurality of plants, wherein a label is positioned on the holding element, the label comprising a clamping portion adapted for partially encompassing the rod and attachable to the rod and removable from the rod, wherein a frame member movable in height above the label rests thereon.

27. A use of a plant support frame according to claim 22, for locating and marking a plant or a plurality of plants, wherein a label is positioned on the holding element, the label comprising a clamping portion adapted for partially encompassing the rod and attachable to the rod and removable from the rod, wherein a frame member movable in height above the label rests thereon.
